(19) United States
(12) Patent Application Publication
(10) Pub. No.: US 2018/0032898 A1
(43) Pub. Date: Feb. 1, 2018

(54) SYSTEMS AND METHODS FOR COMMENT SAMPLING

(71) Applicant: Facebook, Inc., Menlo Park, CA (US)

(72) Inventors: Shaomei Wu, Mountain View, CA (US); Isabel Kloumann, Ithaca, NY (US); Lada Ariana Adamic, Mountain View, CA (US); Erich James Owens, Oakland, CA (US)

(21) Appl. No.: 15/220,733

(22) Filed: Jul. 27, 2016

(51) Int. Cl. G06N 99/00; G06Q 50/00

(52) U.S. Cl. CPC G06N 99/005; G06Q 50/01

(57) ABSTRACT

Systems, methods, and non-transitory computer-readable media can receive a plurality of comments to a posted content item. Each of the plurality of comments is associated with at least one category of a plurality of categories based on a machine learning model. A first comment of the plurality of comments is selected for inclusion in a comment sample to be presented in a graphical user interface based on the first comment being associated with a first category of the plurality of categories. A second comment of the plurality of comments is selected for inclusion in the comment sample based on the second comment being associated with a second category of the plurality of categories.

### FIELD OF THE INVENTION

The present technology relates to the field of social networks. More particularly, the present technology relates to comment sampling.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can interact with content posted by other users on the social networking system. For example, users can share, comment on, and/or post a reaction to (e.g., by clicking a “like” button) another user's posted content on the social networking system. If a particular posted content item has many comments, the posted content item can be presented with a subset, or sample, of the comments. The subset of the comments can be presented to other users to encourage other users to further interact with the posted content item, e.g., by viewing more of the comments to the posted content item, posting their own comment, or posting a response to one of the comments.

### SUMMARY

Various embodiments of the present disclosure can include systems, methods, and non-transitory computer readable media configured to receive a plurality of comments to a posted content item. Each of the plurality of comments is associated with at least one category of a plurality of categories based on a machine learning model. A first comment of the plurality of comments is selected for inclusion in a comment sample to be presented in a graphical user interface based on the first comment being associated with a first category of the plurality of categories. A second comment of the plurality of comments is selected for inclusion in the comment sample based on the second comment being associated with a second category of the plurality of categories.

In an embodiment, the associating each of the plurality of comments with at least one category of the plurality of categories based on the machine learning model comprises determining, based on the machine learning model, whether a comment satisfies a relevance score threshold indicative of relevance to the posted content item.

In an embodiment, the associating each of the plurality of comments with at least one category of the plurality of categories based on the machine learning model comprises determining, based on the machine learning model, whether a comment satisfies an agreement score threshold indicative of agreement with the posted content item.

In an embodiment, the associating each of the plurality of comments with at least one category of the plurality of categories based on the machine learning model comprises determining, based on the machine learning model, whether a comment satisfies a neutrality score threshold indicative of neutrality with regard to the posted content item.

In an embodiment, the associating each of the plurality of comments with at least one category of the plurality of categories based on the machine learning model comprises, for each comment: determining, based on the machine learning model, whether the comment satisfies a relevance score threshold. If the comment is determined not to satisfy the relevance score threshold, the comment is associated with a non-relevance category of the plurality of categories associated with non-relevance to the posted content item. If the comment is determined to satisfy the relevance score threshold, the comment is passed to a second classification determination.

In an embodiment, the second classification determination comprises determining, based on the machine learning model, whether the comment satisfies a neutrality score threshold. If the comment is determined to satisfy the neutrality score threshold, the comment is associated with a neutrality category of the plurality of categories associated with neutrality to the posted content item. If the comment is determined not to satisfy the neutrality score threshold, the comment is passed to a third classification determination.

In an embodiment, the third classification determination comprises determining, based on the machine learning model, whether the comment satisfies an agreement score threshold. If the comment is determined to satisfy the agreement score threshold, the comment is associated with an agreement category of the plurality of categories associated with agreement with the posted content item. If the comment is determined not to satisfy the agreement score threshold, the comment is associated with a disagreement category of the plurality of categories associated with disagreement with the posted content item.

In an embodiment, the first comment is selected for inclusion in the comment sample based on the first comment being associated with the agreement category, and the second comment is selected for inclusion in the comment sample based on the second comment being associated with the disagreement category.

In an embodiment, the method further comprises ranking the plurality of comments based on ranking criteria. The ranking criteria comprise comment engagement information. The selecting the first comment of the plurality of comments is further based on the ranking; and the selecting the second comment of the plurality of comments is further based on the ranking.

In an embodiment, the comment engagement information comprises at least one of a number of likes each comment receives or a number of replies each comment receives.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a comment classification module, according to an embodiment of the present disclosure.

FIG. 2 illustrates an example model application module, according to an embodiment of the present disclosure.

FIG. 3 illustrates an example flow chart for classifying comments, according to an embodiment of the present disclosure.

FIG. 4 illustrates an example method associated with automated comment classification, according to an embodiment of the present disclosure.

FIG. 5 illustrates an example method for automated comment sampling, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Social Network Comment Sampling

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can add friends or contacts, provide, post, or publish content items, such as text, notes, status updates, links, pictures, videos, and audio, via the social networking system.

Users of a social networking system can interact with content posted by other users on the social networking system. For example, users can share, comment on, and/or post a reaction to (e.g., by clicking a “like” button) another user's posted content on the social networking system. If a particular posted content item has many comments, the posted content item can be presented in a graphical user interface along with a subset, or sample, of the comments. The subset of the comments can be presented to other users to encourage other users to further interact with the posted content item, e.g., by viewing more of the comments to the posted content item, posting their own comment, or posting a response to one of the comments.

It continues to be an important interest for a social networking system rooted in computer technology to maximize opportunities for individual users to interact with one another and post content items on the social networking system. In order to incentivize interaction between people with varying viewpoints, it may be advantageous to present a diverse sampling of comments for a posted content item. However, given the enormous amount of content that can be posted to a social networking system, it would be impractical to hand-pick a diverse sampling of comments for each posted content item, and it can be difficult to determine which comments to present in a comment sample. Traditional approaches to selecting a comment sample for a posted content item suffer from several common drawbacks. For example, current comment sampling systems often result in a disproportionate number of comments that are in agreement with the posted content item being selected for the comment sample, rather than presenting a diverse range of viewpoints. Furthermore, current comment sampling systems can potentially be taken advantage of so that irrelevant or uninteresting comments, such as promotional or “spam” comments, are presented in the comment sample, when they are of no interest or benefit to other users.

Therefore, an improved approach can be beneficial for overcoming these and other disadvantages associated with conventional approaches. Based on computer technology, the disclosed technology can categorize each comment for a posted content item into one or more pre-defined categories, so that a diverse range of comments can be selected for a comment sample. For example, each comment can be classified as either agreeing with the posted content item, disagreeing with the posted content item, neutral to the posted content item, or irrelevant to the posted content item. One or more comments from the various categories can be selected for inclusion in the comment sample. For example, a comment sample can be selected to include one comment that agrees with the posted content item, one comment that disagrees with the posted content item, and one comment that is neutral to the posted content item, thereby resulting in a comment sample that presents a more diverse range of attitudes or views. In various embodiments, the classification of comments into the various categories can be performed automatically using a machine learning model. The machine learning model can automatically categorize each comment based on various features of the posted content item and the comment, as will be discussed in greater detail herein. In certain embodiments, the comment sample can be presented in a graphical user interface along with a posted content item. This may be useful, for example, in a situation in which a posted content item has numerous comments, and it would be impractical or otherwise undesirable to present all of the numerous comments (e.g., if the posted content item is being shown in a user's news feed). A diverse sample of the comments can be presented along with the posted content item to, for example, generate interest in the posted content item among users with a diverse range of opinions or views.

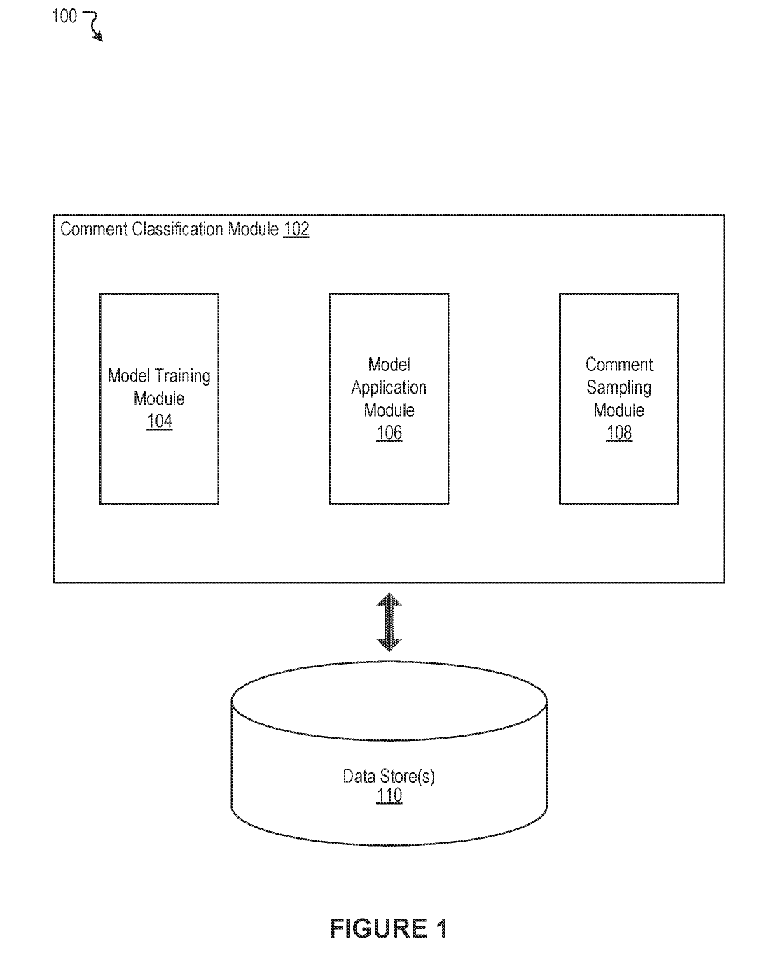

FIG. 1 illustrates an example system 100 including an example comment classification module 102 configured to classify comments into various categories, and to select a comment sample based on the classification, according to an embodiment of the present disclosure. The comment classification module 102 can be configured to train a machine learning model to automatically classify comments into various categories based on classification criteria. The machine learning model can then be applied to comments to automatically classify the comments into the various categories such that each comment is associated with one or more pre-defined categories. The comment classification module 102 can be further configured to select a comment sample based on the association of each comment with one or more categories. For example, the comment classification module 102 can be further configured to rank and/or filter a set of comments for selection of a comment sample.

As shown in the example of FIG. 1, the comment classification module 102 can include a model training module 104, a model application module 106, and a comment sampling module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The model training module 104 can be configured to train a machine learning model based on training data. The training data can include historical social network interaction information. For example, a set of training data comments can be selected. The set of training data comments can be a sampling of comments posted on a social networking system in response to one or more posted content items on the social networking system. Each comment can be manually assigned to one or more pre-defined categories. For example, each comment can be presented to a user along with the posted content item for which the comment was made. The user can be asked to place the comment into a particular category from a set of pre-defined categories. In one embodiment, the user can be asked to classify the comment as either (1) agreeing with the posted content item, (2) disagreeing with the posted content item, (3) being neutral to the posted content item, or (4) being irrelevant to the posted content item. Using these manual classifications as training data, the machine learning model can be trained to determine the relative importance or usefulness of various classification characteristics (or features) in classifying a comment into the pre-defined categories, and to classify or categorize a comment based on the various classification characteristics. Classification characteristics can include any number of characteristics believed to be relevant or useful to the classification of the comment into one of the pre-defined categories.

In certain embodiments, the classification characteristics can include content-based characteristics. Content-based characteristics can be based on the content of the comment and/or the posted content item. For example, content-based characteristics can include the proportion, or number of, words shared by the posted content item and the comment. Content-based characteristics can also include a sentiment determination indicative of a sentiment of the comment. For example, the sentiment determination can be made by assigning a “sentiment” score to words or phrases in the comment to determine an overall sentiment score. The sentiment score can be indicative of the comment's sentiment, e.g., whether the comment is negative or positive. Content-based characteristics can also include a word-diversity determination or word-entropy determination indicative of the variety of words used in a comment. For example, a comment in which the same word is used three times would have a low word-diversity (or high word-entropy), whereas a long, prose-like comment would have a high word-diversity (or low word-entropy). In another example, content-based characteristics can include the number or proportion of letters in a comment that are capitalized, or the amount or types of punctuation used. Content-based characteristics can also include identification of one or more keywords. For example, the use of certain words may indicate a high-likelihood that the comment is promotional (e.g., spam).

In certain embodiments, the classification characteristics can include engagement characteristics. Engagement characteristics can include user interaction information with the comment and/or the posted content item. For example, engagement characteristics can include the number of likes for a comment, or the number of replies to the comment, or the number of (or proportion of) views of the comment that did not lead to any reaction or interaction. Engagement characteristics can also include a number or proportion of users who liked both the posted content item and the comment (e.g., if a high proportion of users liked both the posted content item and the comment, it is likely that the comment is in agreement with the posted content item). In another example, engagement characteristics can include the number or proportion of users who liked the comment who are friends with or otherwise connected to the poster of the comment on a social networking system (e.g., if a comment is only liked by the commenter's friends or connections, it may indicate that the comment is adverse to the posted content item).

The classification characteristics can also include commenter characteristics. For example, commenter characteristics can include past social networking system interaction information for the commenter, such as the length of time the commenter has been on the social networking system, or whether the commenter has previously been reported for inappropriate behavior or promotional (e.g., spam) posts. Commenter characteristics can also include interaction information between the commenter and the poster of the posted content item, such as whether the commenter is friends with, follows, or likes the page of the poster of the posted content item.

The various classification characteristics, some examples of which were discussed above, can be provided to the machine learning model so that the machine learning model can be trained to determine which classification characteristics are most indicative of and/or associated with each pre-defined classification category. For example, it could be determined that a lack of word diversity is most indicative of a comment disagreeing with the original content post. In another example, it could be determined that the proportion of overlapping words between the comment and the original content post is particularly indicative of a comment that agrees with the original content post. In yet another example, it could also be determined that a large number of replies to the comment is highly indicative of a neutral comment. Of course, these are simplified examples, and the machine learning model can utilize multiple classification characteristics in classifying comments into the various pre-defined categories, with each classification characteristic having a different weight or importance placed on it.

The model application module 106 can be configured to utilize the machine learning model to automatically classify a comment into one or more pre-defined categories. For example, as discussed above, each comment can be categorized as either agreeing with, disagreeing with, being neutral to, or being irrelevant to a posted content item. In certain embodiments, the classification of a comment can utilize a tiered or stepped classification system. For example, the machine learning model can be configured to, for each comment, determine first whether the comment is relevant to the posted content item. If the comment is determined to be relevant, then it can be determined whether the comment is neutral to the posted content item. If the comment is determined not to be neutral, then it can be determined whether the comment is in agreement or disagreement with the posted content item. Each tier or step in the classification system can utilize a distinct set of classification characteristics and/or classification characteristic weightings to make the determination. The model application module 106 is discussed in greater detail below.

The comment sampling module 108 can be configured to select a subset of comments, i.e., a comment sample, from a plurality of comments based on the classifications of the comments by the machine learning model. For example, the comment sample module 108 can be configured to filter the plurality of comments based on the comment classifications. Filtering can be performed in order to exclude certain comment categories from the comment sample, e.g., excluding all comments that have been marked by the machine learning model as irrelevant to the posted content item. Filtering can also be performed to ensure that a variety of comments are selected. For example, a comment sample of three comments can be selected by selecting one comment that agrees with the posted content item, one comment that disagrees with the posted content item, and one comment that is neutral to the posted content item.

The comment sampling module 108 can also be configured to rank comments based on ranking criteria. In certain embodiments, ranking may be based on engagement features of each comment. For example, ranking may be performed based on the number of likes and/or replies a comment receives. By ranking the comments, a “top” comment or comments, can be selected from each pre-defined category for inclusion in the comment sample. For example, three comments can be selected for a comment sample based both on their category classification (e.g., agree, disagree, neutral) and their ranking (e.g., the top ranking comment for each category).

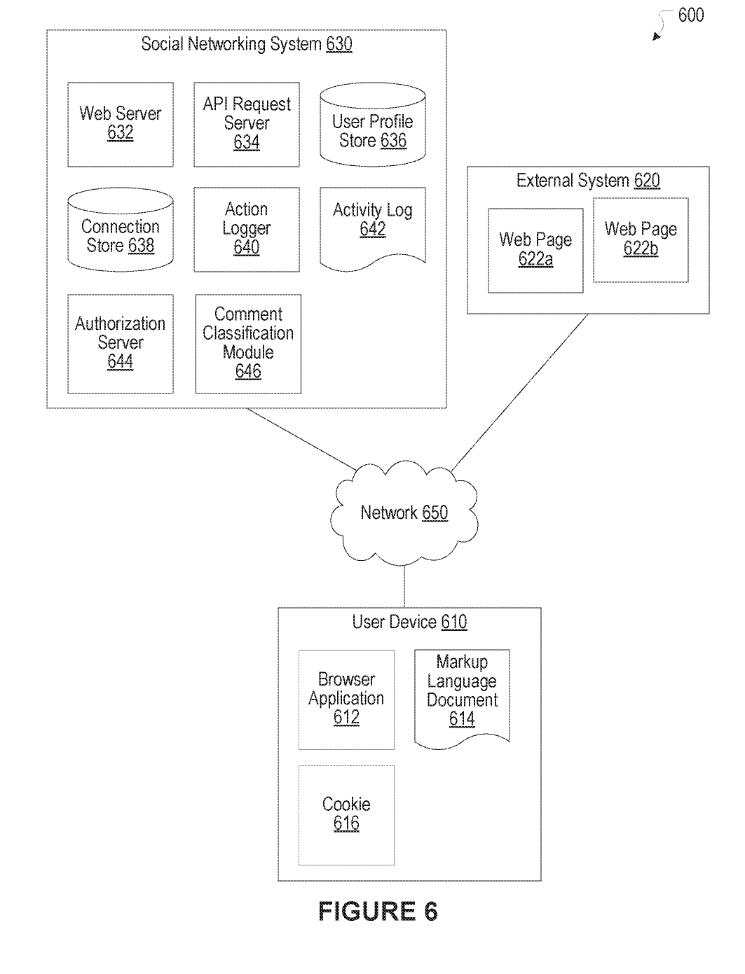

The comment classification module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the comment classification module 102 can be implemented, in part or in whole, as software running on one or more computing devices or systems, such as on a server computing system or a user (or client) computing system. For example, the comment classification module 102 or at least a portion thereof can be implemented as or within an application (e.g., app), a program, or an applet, etc., running on a user computing device or a client computing system, such as the user device 610 of FIG. 6. In another example, the comment classification module 102 or at least a portion thereof can be implemented using one or more computing devices or systems that include one or more servers, such as network servers or cloud servers. In some instances, the comment classification module 102 can, in part or in whole, be implemented within or configured to operate in conjunction with a social networking system (or service), such as the social networking system 630 of FIG. 6. It should be understood that there can be many variations or other possibilities.

The comment classification module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the comment classification module 102. For example, the data store 110 can store various machine learning models, past social networking data, model training data, manual comment classifications, and the like, as described in greater detail herein. It is contemplated that there can be many variations or other possibilities.

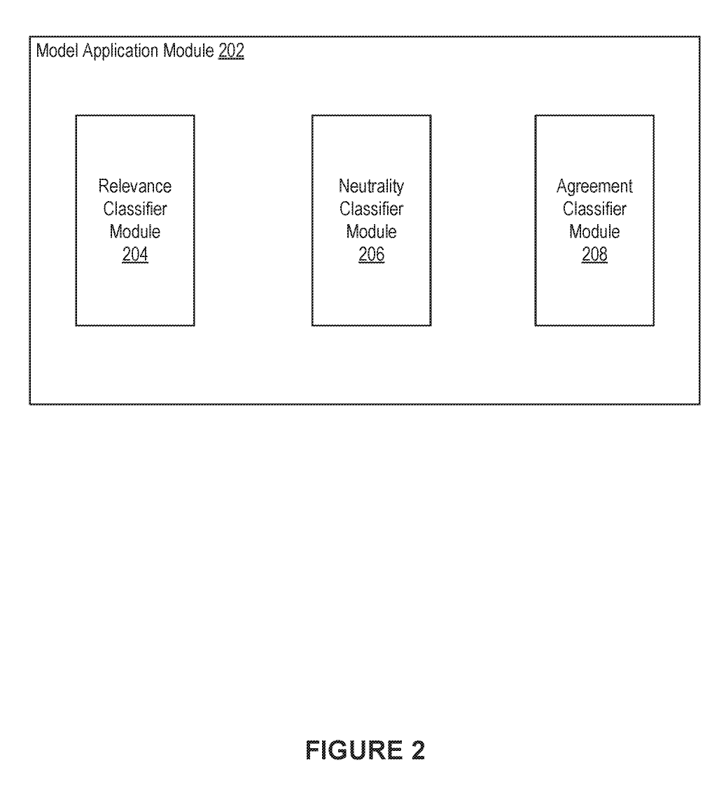

FIG. 2 illustrates an example model application module 202 configured to automatically classify a comment into one or more pre-defined categories based on a machine learning model, according to an embodiment of the present disclosure. In some embodiments, the model application module 106 of FIG. 1 can be implemented as the example model application module 202. As shown in FIG. 2, the model application module 202 can include a relevance classifier module 204, a neutrality classifier module 206, and an agreement classifier module 208.

As discussed briefly above, the machine learning model can be configured to classify a comment into one or more pre-defined categories based on various classification characteristics. The classification of a comment into the one or more pre-defined categories can be performed in a tiered manner, such that a particular determination is made at each tier before moving on to the next tier. In the example model application module 202, classification of comments is performed in three tiers: a relevance classification, a neutrality classification, and an agreement classification. While the present example discusses the machine learning model as a single model separated into three classification tiers, it should be understood that the disclosure can be understood to be and/or implemented as multiple individual models.

The relevance classifier module 204 can be configured to make a relevance determination for a comment in view of a posted content item based on various relevance classification criteria. As discussed above, a machine learning model can be trained using training data, including historical social networking information, and can be configured to determine which classification criteria are most useful in predicting whether a comment is relevant to a posted content item based on the training data. For example, if the poster of the comment has been previously reported for posting spam or promotional comments, and if the comment contains certain keywords or phrases indicative of a promotional or spam comment, then the comment may be determined to have a high likelihood of being irrelevant to the posted content item. Similarly, it may be suggestive of an irrelevant comment if a comment has very few or no words in common with the posted content item. In certain embodiments, a relevance score (or irrelevance score) can be calculated for a comment based on relevance classification criteria. If the comment does not satisfy a relevance score threshold (or if it does satisfy an irrelevance score threshold), the comment can be classified into a “non-relevance” category indicative of non-relevance to the posted content item. In certain embodiments, once a comment is classified into the non-relevance category, classification of the comment is completed. If the comment is not classified as not relevant, i.e., relevant (e.g., it satisfies a relevance score threshold or does not satisfy an irrelevance score threshold), then the comment can be passed on to the next classification determination.

The neutrality classifier module 206 can be configured to make a neutrality determination for a comment in view of a posted content item based on various neutrality classification criteria. Once again, the machine learning model can be configured to determine, based on training data, which classification criteria are most useful in predicting whether or not a comment is neutral to a posted content item. It should be evident that the neutrality classification criteria may be different from the relevance classification criteria discussed above. For example, whereas past user misbehavior, and certain promotional or spam keywords may be indicative of an irrelevant comment, a neutral comment may be indicated by a large number of replies to the comment, or a large ratio of replies-to-likes. In certain embodiments, the machine learning model can calculate a neutrality score for a comment based on the neutrality classification criteria. If the comment satisfies a neutrality score threshold, then the comment can be classified into a neutrality category indicative of neutrality with respect to the posted content item. Conversely, if the comment does not satisfy the neutrality score threshold, then the comment can be passed to the next classification determination. It should be understood that while the present example discusses a “neutrality score” and “neutrality score threshold,” this may be carried out in various ways. For example, rather than a neutrality score, the machine learning model can determine a contentiousness score, such that if a comment does not satisfy a contentiousness score threshold, it is categorized as “neutral,” and if it does satisfy the contentiousness score threshold, the comment is passed to the next classification determination.

The agreement classifier module 208 can be configured to determine whether a comment agrees with or disagrees with a posted content item based on various agreement classification criteria. The machine learning model can be configured to determine which classification criteria are most useful in predicting whether a comment agrees with or disagrees with a posted content item based on training data. Again, the agreement classification criteria may differ from the relevance classification criteria and the neutrality classification criteria discussed above. For example, a lack of word diversity may be indicative of a comment that disagrees with the posted content item, whereas a comment that has a large number, or proportion, of words that overlap with the posted content item may be indicative of a comment that agrees with the posted content item. In certain embodiments, the machine learning model can calculate an agreement score and/or a disagreement score for a comment. The comment can be categorized into an agreement category (indicative of agreement with the posted content item) or a disagreement category (indicative of disagreement with the posted content item) based on the calculated score(s). In certain embodiments, an agreement score threshold or disagreement score threshold may be utilized to make the classification. In certain embodiments, the classification of a comment into the agreement category or the disagreement category can be implemented in a binary fashion. For example, in the example tiered decision structure disclosed herein, each comment that has reached the agreement classification determination has already been determined to be relevant, and has already been determined not to be neutral. As such, since the comment is relevant, and is not neutral, the only determination left to be made is whether the comment agrees with or disagrees with the posted content item, and the comment must be categorized into one of the two categories.

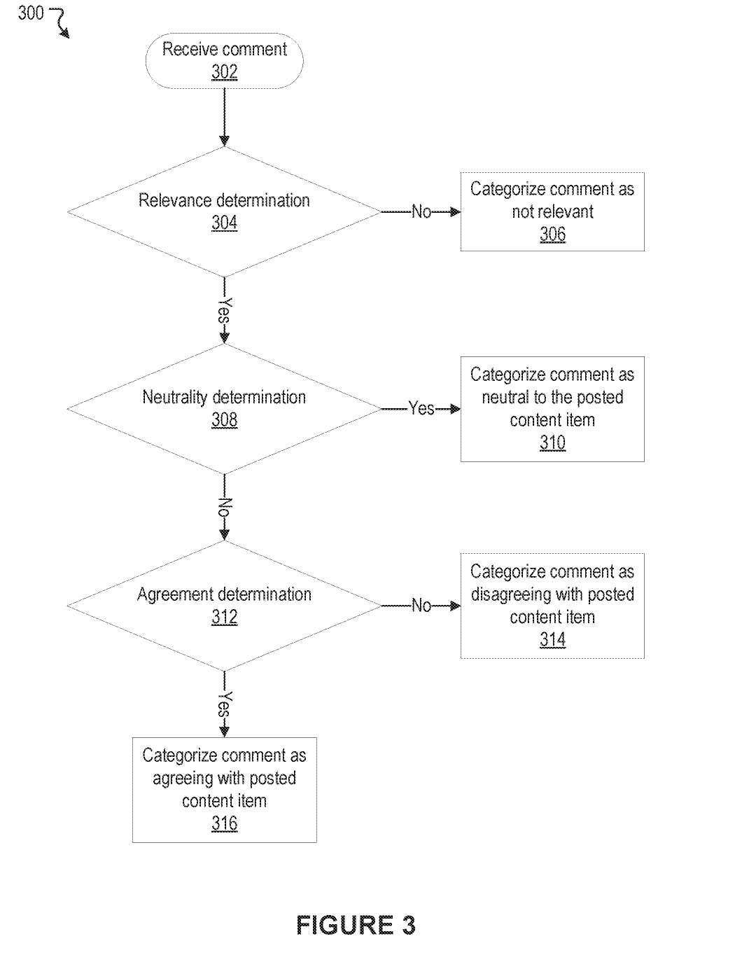

FIG. 3 illustrates an example flow chart 300 associated with classifying a comment into one of four pre-defined categories, according to an embodiment of the present disclosure. At block 302, the comment is received. At block 304, a relevance determination is made based on a machine learning model and relevance classification criteria. If the comment is determined not to be relevant to a posted content item by, for example, failing to satisfy a relevance score threshold, the comment is categorized as not relevant (e.g., placed into a non-relevance category) (block 306). If the comment satisfies the relevance score threshold, the comment moves to block 308. At block 308, a neutrality determination is made based on the machine learning model and neutrality classification criteria. If the comment is determined to be neutral to the posted content item by, for example, satisfying a neutrality score threshold, the comment is categorized as neutral to the posted content item (e.g., placed into a neutrality category) (block 310). If the comment does not satisfy the neutrality score threshold, the comment moves to block 312. At block 312, an agreement determination is made based on the machine learning model and agreement classification criteria. If the comment is determined to be more likely to be in disagreement with the posted content item than in agreement (e.g., by failing to satisfy an agreement score threshold, or satisfying a disagreement score threshold), then the comment is categorized as disagreeing with the posted content item (e.g., placed into a disagreement category) (block 314). Conversely, if the comment is determined to be more likely to be in agreement with the posted content item than in disagreement (e.g., by satisfying an agreement score threshold), then the comment is categorized as agreeing with the posted content item (e.g., placed in an agreement category) (block 316). Although the above-described tiered comment classification system describes a system in which comments are assigned to a single category, it should be understood that, in various embodiments, comments can be assigned to multiple categories.

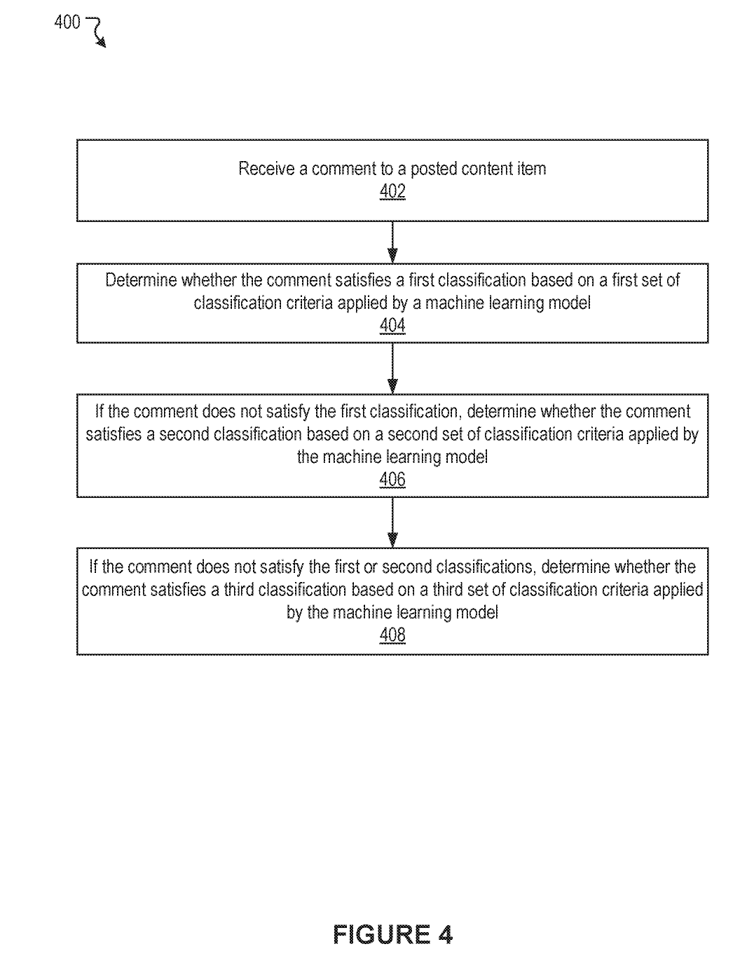

FIG. 4 illustrates an example method 400 associated with automated comment classification based on a machine learning model, according to an embodiment of the present disclosure. It should be appreciated that there can be additional, fewer, or alternative steps performed in similar or alternative orders, or in parallel, based on the various features and embodiments discussed herein unless otherwise stated.

At block 402, the example method 400 can receive a comment to a posted content item. At block 404, the example method 400 can determine whether the comment satisfies a first classification based on a first set of classification criteria applied by a machine learning model. At block 406, the example method 400 can, if the comment does not satisfy the first classification, determine whether the comment satisfies a second classification based on a second set of classification criteria applied by the machine learning model. At block 408, the example method 400 can, if the comment does not satisfy the first or second classifications, determine whether the comment satisfies a third classification based on a third set of classification criteria applied by the machine learning model. Other suitable techniques that incorporate various features and embodiments of the present technology are possible.

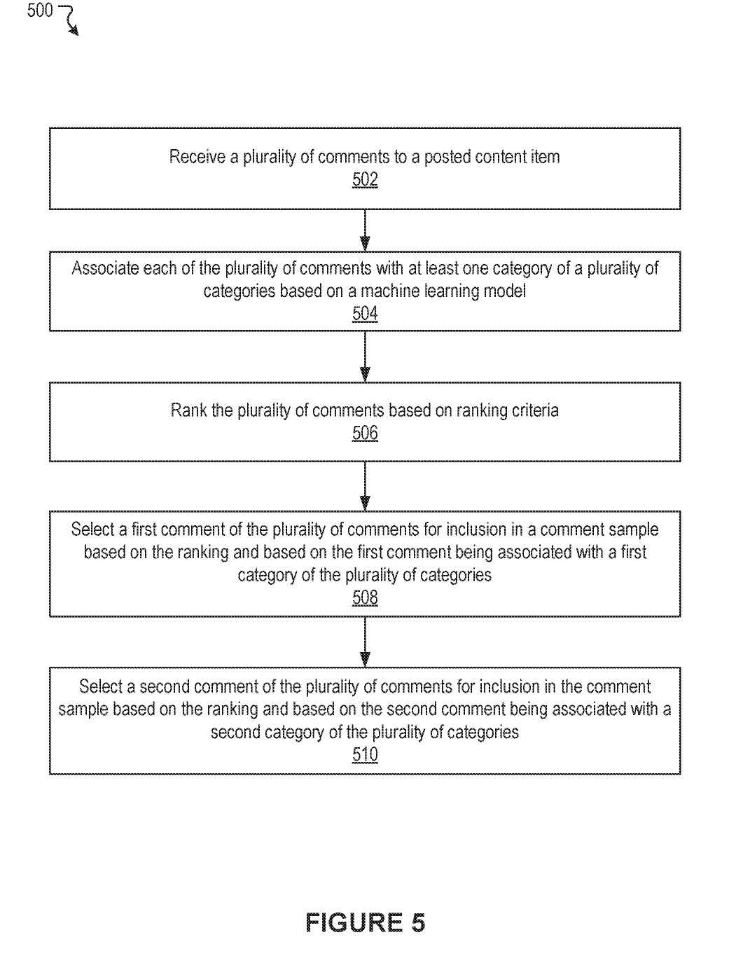

FIG. 5 illustrates an example method 500 associated with automated comment sampling, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can receive a plurality of comments to a posted content item. At block 504, the example method 500 can associate each of the plurality of comments with at least one category of a plurality of categories based on a machine learning model. At block 506, the example method 500 can rank the plurality of comments based on ranking criteria. At block 508, the example method 500 can select a first comment of the plurality of comments for inclusion in a comment sample based on the ranking and based on the first comment being associated with a first category of the plurality of categories. At block 510, the example method 500 can select a second comment of the plurality of comments for inclusion in the comment sample based on the ranking and based on the second comment being associated with a second category of the plurality of categories. Other suitable techniques that incorporate various features and embodiments of the present technology are possible.

### Social Networking System-Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and provides users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a comment classification module 646. The comment classification module 646 can, for example, be implemented as the comment classification module 102, as discussed in more detail herein. As discussed previously, it should be appreciated that there can be many variations or other possibilities. For example, in some embodiments, one or more functionalities of the comment classification module 646 can be implemented in the user device 610.

### Hardware Implementation

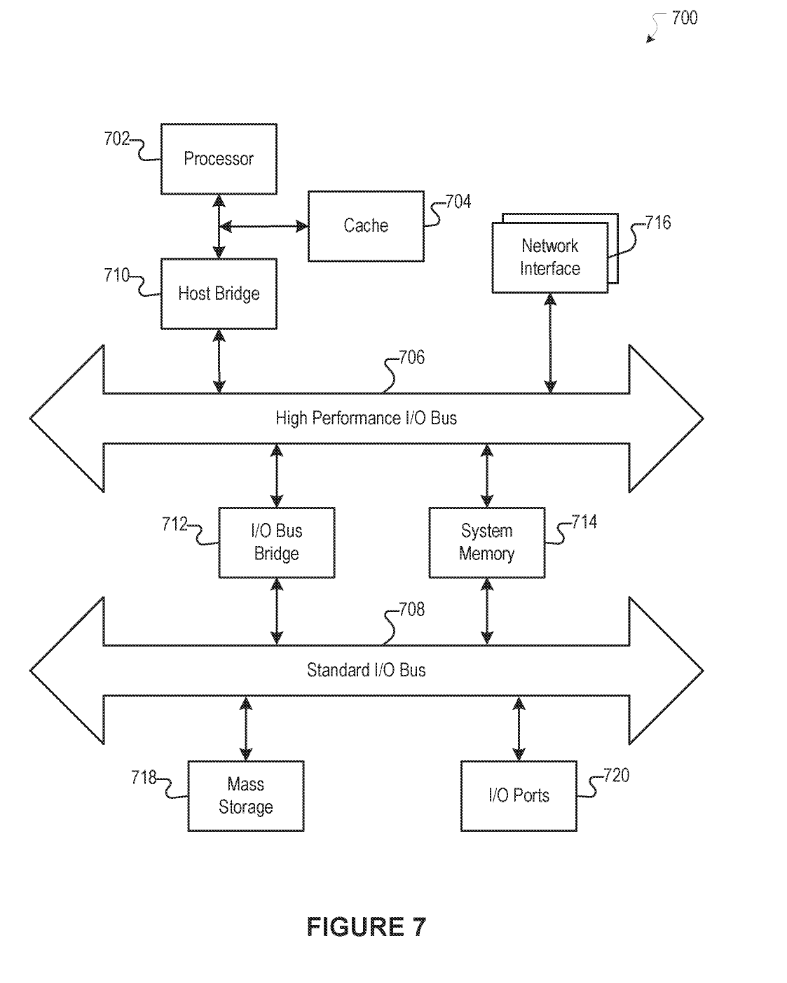

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a plurality of comments to a posted content item;
associating, by the computing system, each of the plurality of comments with at least one category of a plurality of categories based on a machine learning model;
selecting, by the computing system, a first comment of the plurality of comments for inclusion in a comment sample to be presented in a graphical user interface based on the first comment being associated with a first category of the plurality of categories; and
selecting, by the computing system, a second comment of the plurality of comments for inclusion in the comment sample based on the second comment being associated with a second category of the plurality of categories.

2. The computer-implemented method of claim 1, wherein the associating each of the plurality of comments with at least one category of the plurality of categories based on the machine learning model comprises
determining, based on the machine learning model, whether a comment satisfies a relevance score threshold indicative of relevance to the posted content item.

3. The computer-implemented method of claim 1, wherein the associating each of the plurality of comments with at least one category of the plurality of categories based on the machine learning model comprises
determining, based on the machine learning model, whether a comment satisfies an agreement score threshold indicative of agreement with the posted content item.

4. The computer-implemented method of claim 1, wherein the associating each of the plurality of comments with at least one category of the plurality of categories based on the machine learning model comprises
determining, based on the machine learning model, whether a comment satisfies a neutrality score threshold indicative of neutrality with regard to the posted content item.

5. The computer-implemented method of claim 1, wherein the associating each of the plurality of comments with at least one category of the plurality of categories based on the machine learning model comprises, for each comment:
determining, based on the machine learning model, whether the comment satisfies a relevance score threshold, and
if the comment is determined not to satisfy the relevance score threshold, associating the comment with a non-relevance category of the plurality of categories, the non-relevance category associated with non-relevance to the posted content item, and
if the comment is determined to satisfy the relevance score threshold, passing the comment to a second classification determination.

6. The computer-implemented method of claim 5, wherein the second classification determination comprises:
determining, based on the machine learning model, whether the comment satisfies a neutrality score threshold, and
if the comment is determined to satisfy the neutrality score threshold, associating the comment with a neutrality category of the plurality of categories, the neutrality category associated with neutrality to the posted content item, and
if the comment is determined not to satisfy the neutrality score threshold, passing the comment to a third classification determination.

7. The computer-implemented method of claim 6, wherein the third classification determination comprises:
determining, based on the machine learning model, whether the comment satisfies an agreement score threshold, and
if the comment is determined to satisfy the agreement score threshold, associating the comment with an agreement category of the plurality of categories, the agreement category associated with agreement with the posted content item, and
if the comment is determined not to satisfy the agreement score threshold, associating the comment with a disagreement category of the plurality of categories, the disagreement category associated with disagreement with the posted content item.

8. The computer-implemented method of claim 7, wherein
the first comment is selected for inclusion in the comment sample based on the first comment being associated with the agreement category, and
the second comment is selected for inclusion in the comment sample based on the second comment being associated with the disagreement category.

9. The computer-implemented method of claim 1, further comprising ranking the plurality of comments based on ranking criteria, wherein
the ranking criteria comprise comment engagement information,
the selecting the first comment of the plurality of comments is further based on the ranking, and
the selecting the second comment of the plurality of comments is further based on the ranking.

10. The computer-implemented method of claim 9, wherein the comment engagement information comprises at least one of
a number of likes each comment receives or
a number of replies each comment receives.

11. A system comprising:
at least one processor; and
a memory storing instructions that, when executed by the at least one processor, cause the system to perform a method comprising:
receiving a plurality of comments to a posted content item;
associating each of the plurality of comments with at least one category of a plurality of categories based on a machine learning model;
selecting a first comment of the plurality of comments for inclusion in a comment sample to be presented in a graphical user interface based on the first comment being associated with a first category of the plurality of categories; and
selecting a second comment of the plurality of comments for inclusion in the comment sample based on the second comment being associated with a second category of the plurality of categories.

12. The system of claim 11, wherein the associating each of the plurality of comments with at least one category of the plurality of categories based on the machine learning model comprises
determining, based on the machine learning model, whether a comment satisfies a relevance score threshold indicative of relevance to the posted content item.

13. The system of claim 11, wherein the associating each of the plurality of comments with at least one category of the plurality of categories based on the machine learning model comprises
determining, based on the machine learning model, whether a comment satisfies an agreement score threshold indicative of agreement with the posted content item.

14. The system of claim 11, wherein the associating each of the plurality of comments with at least one category of the plurality of categories based on the machine learning model comprises
determining, based on the machine learning model, whether a comment satisfies a neutrality score threshold indicative of neutrality with regard to the posted content item.

15. The system of claim 11, wherein the associating each of the plurality of comments with at least one category of the plurality of categories based on the machine learning model comprises, for each comment:
determining, based on the machine learning model, whether the comment satisfies a relevance score threshold, and
if the comment is determined not to satisfy the relevance score threshold, associating the comment with a non-relevance category of the plurality of categories, the non-relevance category associated with non-relevance to the posted content item, and
if the comment is determined to satisfy the relevance score threshold, passing the comment to a second classification determination.

16. A non-transitory computer-readable storage medium including instructions that, when executed by at least one processor of a computing system, cause the computing system to perform a method comprising:
receiving a plurality of comments to a posted content item;
associating each of the plurality of comments with at least one category of a plurality of categories based on a machine learning model;
selecting a first comment of the plurality of comments for inclusion in a comment sample to be presented in a graphical user interface based on the first comment being associated with a first category of the plurality of categories; and
selecting a second comment of the plurality of comments for inclusion in the comment sample based on the second comment being associated with a second category of the plurality of categories.

17. The non-transitory computer-readable storage medium of claim 16, wherein the associating each of the plurality of comments with at least one category of the plurality of categories based on the machine learning model comprises
determining, based on the machine learning model, whether a comment satisfies a relevance score threshold indicative of relevance to the posted content item.

18. The non-transitory computer-readable storage medium of claim 16, wherein the associating each of the plurality of comments with at least one category of the plurality of categories based on the machine learning model comprises
determining, based on the machine learning model, whether a comment satisfies an agreement score threshold indicative of agreement with the posted content item.

19. The non-transitory computer-readable storage medium of claim 16, wherein the associating each of the plurality of comments with at least one category of the plurality of categories based on the machine learning model comprises
determining, based on the machine learning model, whether a comment satisfies a neutrality score threshold indicative of neutrality with regard to the posted content item.

20. The non-transitory computer-readable storage medium of claim 16, wherein the associating each of the plurality of comments with at least one category of the plurality of categories based on the machine learning model comprises, for each comment:
determining, based on the machine learning model, whether the comment satisfies a relevance score threshold, and
if the comment is determined not to satisfy the relevance score threshold, associating the comment with a non-relevance category of the plurality of categories, the non-relevance category associated with non-relevance to the posted content item, and
if the comment is determined to satisfy the relevance score threshold, passing the comment to a second classification determination.
